(19) United States
(12) Patent Application Publication
(10) Pub. No.: US 2003/0225637 A1
(43) Pub. Date: Dec. 4, 2003

(54) Control apparatus

(76) Inventors: Steven Lennard Pemberton, Kingsley (GB); Christopher Neal, Chester (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/448,531

(22) Filed: May 30, 2003

(30) Foreign Application Priority Data
May 31, 2002 (GB) 0212646.4

(51) Int. Cl. G06F 17/60

(52) U.S. Cl. 705/28

(57) ABSTRACT

An apparatus for controlling a supply chain of a composite product by a user includes a storage device adapted to store composite product data including outlet data, primary supplier data, and secondary supplier data, a communication device for providing the storage device with outlet data, primary supplier data, and secondary supplier data and a control device for controlling the supply of composite products and product parts. The control device comprises a mechanism for instructing the primary suppliers and/or secondary suppliers to supply products and/or parts and a monitor mechanism for monitoring the stored composite product data and activating the instruction mechanism to enable efficient supply of products to the outlets.

### BACKGROUND OF THE INVENTION

The invention relates to an apparatus for controlling the supply of a product and to a method of controlling the supply of a product, particularly but not exclusively to a supply chain management apparatus for controlling the supply of composite products.

Nowadays, the supply of multiple goods or products by a company to multiple outlets, such as retail outlets, is very complicated due to the large number of different products that are supplied to the outlet, the variable turnover of the various products, the frequent changes to product lines which render existing products obsolete, and the complicated supply chain of suppliers and sub-suppliers.

The flow of the various product streams are controlled by means of multiple transactions between the outlet organization, suppliers, and sub-suppliers involving a large number of people. Invariably, management and control of the supply of the products to the outlets is laborious, complicated, and generally slow, whereby changes to product lines are difficult to implement at short notice due to the large number of suppliers involved in the supply chains and the complexity of the supply chains. As a result, product lines are altered or discontinued at a relatively low rate, and the discontinuation of product lines results in large numbers of redundant stocks. This is undesirable as it increases waste and increases the overall cost of the retail products. Overall existing management of the supply chain is inefficient. Within the context of the application, efficient supply of products relates to a supply of products whereby the products are not over-supplied (which results in increased stocks) nor under-supplied (which results in the product demand not being met). Both oversupply and under-supply are not desirable as this increases the cost of the supply of products.

It is therefore desirable to provide an improved system or apparatus for controlling a supply chain, and a method for controlling a supply chain, which allow more efficient supply of products to the outlets and whereby product waste is reduced, thereby addressing the above described problems and/or to provide improvements generally.

### SUMMARY OF THE INVENTION

In embodiments of the present invention, there are provided an apparatus for controlling a supply chain, and a method of controlling a supply chain, according to any of the accompanying claims.

In an embodiment of the invention, there is provided an apparatus for controlling a supply chain comprising one or more primary suppliers for supplying a composite product to one or more outlets and one or more secondary suppliers for supplying parts of said composite product. The parts are supplied by sub-suppliers or secondary suppliers, whereas the composite product itself is supplied by one or more primary suppliers. The apparatus may comprise a storage means adapted to store outlet data, primary supplier data, and secondary supplier data, communication means for providing the storage means with outlet inventory data, primary supplier inventory data, and secondary supplier inventory data, a control means for controlling the supply of composite products and product parts on the basis of the stored data, thereby providing an efficient supply of the composite products to the outlets.

In another embodiment of the invention, the control means may comprise means for instructing the primary suppliers and/or secondary suppliers and monitor means for monitoring the stored product data and activating the instruction means to enable efficient supply of products and product parts to the outlets. The instructions may comprise number of products to be supply, delivery dates/times, production times, product details, etc.

The outlet data may comprise the outlet demand and/or outlet inventory. The outlet data may also comprise the outlet sales rate. The monitoring means may activate the instruction means if the data, preferably the outlet inventory data, are below a predetermined value. The predetermined value may be based on the product demand and/or minimum outlet stock level and/or sales price of parts and/or sales rate etc. In this way inefficient supply of the outlets is prevented.

The control means may further comprise means for adapting the supply of products and product parts to the outlet data, thereby providing a sufficient outlet inventory, while preventing inefficient supply of products and product parts to the outlets. In this way, it is achieved that the supply of products is adapted to the outlet demand. This reduces product wastage and allows stocks of the various products to be as small as possible. This greatly improves efficiency of the supply chain and greatly reduces costs to both retailers, primary suppliers and secondary suppliers.

In another embodiment, the monitoring means may monitor parts inventories and instruct secondary suppliers and/or primary suppliers on that basis. This prevents inefficient supply of products and product parts to the primary suppliers and/or secondary suppliers. In this way, every supply stage in the supply chain may be optimized and improved for best efficiency.

In a further embodiment, the apparatus may comprise interface means for receiving instructions from a user. The user in this context may be a company or retail organization which uses the apparatus for controlling the supply of its outlets with the products. In this way, the control means may be fully or partially user controlled. Alternatively, the control means may be automated.

In another embodiment, the user may control the control means via the interface means so that for the various retail products, the various supply chains may be controlled. The interface means may be adapted to enter a new product and/or new product parts and/or new primary suppliers and/or secondary suppliers and/or remove products and/or remove product parts.

In a further embodiment, the apparatus may comprise further interface means, the further interface means being adapted to enable communication between a user and one or more suppliers. The control means may be instructing the primary suppliers and/or part secondary suppliers to supply respective products and/or parts via the further interface means. The further interface means may also be adapted to communicate requests to supply from a user, and the interface means may be adapted to receive offers from said primary suppliers and/or product secondary suppliers.

In yet another embodiment of the invention, the storage means may be adapted to store inventory data relating to a single product in a product record. Such a product record corresponds to the supply chain information for a specific product. The apparatus may allow the user, primary suppliers, and secondary suppliers access to the product record via the interface means. In this way the suppliers may keep themselves up to date with the progress of the product and all necessary inventory details are readily available to each primary supplier and secondary supplier. Access means may be provided to control access to the inventory data and/or product records. The user, primary supplier, and secondary supplier may each have predefined access to their respective workers to prevent abuse of inventory data and to secure secrecy between the various primary suppliers and secondary suppliers.

In a further embodiment, the apparatus may comprise interface means for enabling the outlets and/or the primary suppliers and/or the secondary suppliers to view the stored inventory data. The interface means may further comprise access means for controlling access to the inventory data. In this way, unauthorized access may be prevented to sensitive information. In this way, it is achieved that the supply of products and product parts is monitored so that instantaneously, the product inventories and product part inventories are available to the user of the system, the primary suppliers, and the product secondary suppliers so that the suppliers are aware of the number of products and product parts necessary to supply the product to the outlet.

The control means is generally controlled by the user on the basis of the monitored inventory data. However, the control means may also be automated so that the primary suppliers and/or secondary suppliers are automatically updated of the number of products required to be supplied. To that effect, instruction means may automatically instruct the primary suppliers and/or secondary suppliers to supply the required products and/or product parts. The actual instructions as issued by the control means may be communicated via the respective interface means to the primary suppliers and/or secondary suppliers.

In another embodiment of the invention, the apparatus may comprise selection means for selecting the primary supplier and/or secondary suppliers. The primary suppliers and/or secondary suppliers may be selected on the basis of the supplier product inventory data and/or on cost for supplying products or product parts. The selection means may comprise cost calculating means, said selection means being configured to select the suppliers on the basis of the calculated cost of supplying the product and/or the product part.

In yet another embodiment of the invention, the selection means may comprise a tender system. The tender system may comprise means for requesting offers from the primary suppliers and/or secondary suppliers, the tender system further comprising offer acceptance means for accepting the offers, the supplier being selected on the basis of a cost effective offer. In this way, it is possible to select the cheapest or most cost effective supplier. The tender system may be automated or conducted by the user.

In yet another embodiment, the outlet data may comprise an outlet product inventory. The supplier data may comprise a primary supplier product inventory and a parts inventory. The secondary supplier data may comprise a parts inventory. The apparatus may be adapted to control multiple supply chains and/or the supply of multiple composite products. The apparatus may further comprise audit means for auditing the supply of products and/or product parts. A fourth communication means may provide the audit means with stored inventory data.

In yet another embodiment, the apparatus is adapted to control the supply chain of packaged products. The composite product may comprise a packaged product comprising a product, packaging and a label. The supply chain may comprise secondary suppliers or sub-suppliers in the form of printers, artwork developers, packaging manufacturers, and product manufacturers. The supply chain may further comprise primary suppliers which supply the packaged and labeled product. The outlets may comprise retail outlets. The apparatus provide the control of the supply chain and monitors inventory levels to prevent inefficient supply of the packaged product to the retail outlet.

In a further embodiment, the apparatus may comprise a software system implemented on a computer platform, the computer platform comprising a central server.

In yet another embodiment of the invention, the storage means may comprise a project storage means, the project storage means being adapted to store projects. A project may comprise data relating to the products and product parts to be supplied to the outlet from selected primary suppliers and/or secondary suppliers. The control means may be adapted to control the supply in accordance with the project data.

The interface means may comprise viewing means in the form of a web browser or such like to reproduce the data as stored within the storage means to the primary supplier and/or secondary supplier. To prevent abuse of data by third parties, the data is preferably encrypted whereby the data may only be viewed by designated viewing means.

In another embodiment, the supply chain management apparatus may be implemented on a computer system comprising a storage means in the form of a database, a control means in the form of a database management system, and an interface means in the form of a database access means using viewers or browsers, the communication means being provided by remote links which may comprise Internet connections from the user/suppliers to the database.

In yet another embodiment of the invention, there is provided a method for controlling a supply chain.

There is thus provided an apparatus for controlling a supply chain and a method for controlling a supply chain.

The supply of products to retail outlets is complicated due to the large number of products, large number of suppliers, long supply chains and the frequent changes in product lines and the product status. Management of the supply of retail products to the outlets is generally conducted by a number of workers with the aid of automated tools, such as computerized ordering systems. However, due to the above described complex aspects, the supply of products to retail outlets is inefficient. As a result, the costs for managing the supply of products are substantial and a large number of products are wasted due to management errors and delays (lead times) in the supply chain in supplying the relevant products or product parts.

We have discovered that these problems may be largely overcome by a system comprising a supply chain management system for controlling the supply of the products to one or more outlets which comprises a database for storing the product inventories and product data of the various primary suppliers and the various secondary suppliers in the supply chain, the supply chain management system further comprising monitoring means for monitoring the inventories on the database and a control means for controlling the supply of products and product parts on the basis of the monitored inventories. The stored data are accessible to the outlets, user or retail organization, and suppliers via interface means.

In this way, since all data are directly accessible and centrally available, it is possible to directly instruct both secondary suppliers and primary suppliers so that the supply of goods is optimized and the outlet is provided with sufficient numbers of products. In addition, the system provides the primary suppliers and secondary suppliers access to stored inventories so that the inventories are readily accessible by the suppliers. In this way, the suppliers can instantaneously view the demand of products and can supply products in accordance thereto. Essentially, the apparatus as hereinbefore described is a work flow management tool.

In another embodiment, the supply chain management system comprises a record or project database system which contains product projects. A product project comprises details of a specific product line including the inventory data of product primary suppliers and product secondary suppliers. The control means control the supply of products in accordance with the requirements of the project.

In another embodiment, the system may comprise a means for inviting suppliers to make an offer to supply products at a specific cost, the system further comprising means for selecting such offers and accepting these. On the basis of this, the control means may select suitable suppliers for the product.

The system as hereinbefore described may be adapted to manage business processes, more in particular a supply chain business process. An objective of the system is to enable better quality decisions in the supply chain to reduce waste and minimize real costs.

Essentially, the system is a web based system with a central server. The system comprises the storage means in the form of a database and portals through which the server may be accessed. The portals are preferably connected to the server via the Internet so that the server is central to the system, whereby the server with its database is continuously updated with the inventories of the outlets, primary suppliers and secondary suppliers. The system may comprise information and product inventories and outlet inventories and the system may be used to manage the flow of labels, packaging materials, and products. When applied to the provision of labeled products to a retail outlet, the system may comprise a database comprising entries of the labeled and packaged products in the retail outlet, the numbers and types of labels available, suppliers of labels and label printers. The database may be managed by a user whereby the user effectively manages the control means of the database. Alternatively, the database may be fully automated whereby the supply of products is controlled without any user intervention.

The project database may be accessible to supply chain users such as printers, packers of goods, artwork designers, etc. The inventory is open in that the database manager can enter requirements for labels, put out tenders, and view the states of labels. The system automatically sends out reminders to suppliers to supply labels and keeps track of deadlines and requirements. Furthermore, there is provided a tendering system for requesting costings on labels which includes information on the label requirements. The system is logged and auditable. Tenders may not be altered. Suppliers bids are ranked by cost and may be viewed by the user. The system further comprises a search facility. In addition, the inventories and other information stored on the database may be labeled by identifiers which allow the information to be selectively available to the various suppliers and users depending on the identifying label connected with the user and/or suppliers.

The system is primarily designed for retailers and retail managers, such as retail chain owners, to have an immediate view of the progress of the supply of products and product inventories of the supply chain. The suppliers in the supply chain also have an immediate, instantaneous view of their inventories and secondary suppliers' inventories so that adequate measures may be taken to prevent inefficient supply of product and to prevent bottle necks in the supply chain. In addition, the system allows communication between the retailer, retail manager, primary suppliers, and secondary suppliers. Finally, as multiple primary suppliers and secondary suppliers have access to the system, different primary suppliers and secondary suppliers may be instantaneously selected depending on their inventory data to secure cost effective and efficient supply of products to the outlets. This effectively allows supply chains to be changed if, in the circumstances, this improves the product supply efficiency to the outlets. The system may be used for any item used by an outlet or retailer, such as packaged products, carrier bags, till rolls, uniform, etc.

Features of the system may comprise a multi-database approach which allows flexible service levels to be achieved. The multiple database allows access to information by primary suppliers, users, and secondary suppliers, whereby the levels of information may vary depending on the type of user. The storage means in the form of the database may comprise dual databases to allow storage and management of data relating to labels and all other packaging formats. Data integrity may be protected by having web access as a viewing window on the data as opposed to a web held database. This prevents unauthorized usage of the data and prevents data from being altered by the user. A further advantage of this arrangement is that the data are always up to date. Different packaging types may be linked by way of common secondary suppliers and primary suppliers.

Supply chain partners in the form of primary suppliers and/or secondary suppliers may be able to upload documents/images onto the database via a two stage validation procedure. In this way, data can be transferred by the system to the various suppliers down the supply chain. This again increases efficiency and promotes operation of the system.

To further secure the system and to allow the system to be used as a accountancy tool, the system may comprise status control, full audit trails, and document storage facilities to allow the system to be fully auditable. An advantage of the system is that once a product becomes obsolete, this is advertised instantaneously to the primary suppliers and secondary suppliers. This helps to minimize the cost of redundant inventory and helps to reduce waste. In addition, the system may comprise a product project management database. The project management database may comprise additional communication means for communicating with the primary suppliers and/or secondary suppliers, storage means for storing a project, a project progress database for monitoring progress of a project, the project progress database automatically being updated as project milestones are being achieved.

The system further comprises a supply chain information portal which allows real time collaborative working for external users by a standard browser technology. Shared access to data may be provided and the collation of inventory levels of any given item at several points in the supply chain may be available to the suppliers. The supply chain partners may interrogate the system using locally known references. The system may further comprise an automated tender process which has the ability to issue a paperless tender to a chosen number of qualified vendors. The tender offers are collated and ranked, all this may be in a completely auditable way. The automated tender process utilizes existing e-mail systems to facilitate communication. Furthermore, according to another advantageous embodiment, the system provide quality commercial feedback to account managers when making business allocation decisions. Also, it quotes a history which is available to partners on-line and it may increase efficiency in a tender process.

In yet another embodiment of the invention, there may be provided a stock integration means. This enables better inventory management and production planning to the primary suppliers and secondary suppliers. Also it provides an instantaneous visual representation of parts usage and products usage which is available as the stock integration means may be viewed via web access.

In a preferred embodiment, a framework for the database may be provided by SQL server. This is an industry standard database environment.

A further advantage of the supply chain management system is that it provides the ability to migrate the system and link it to any other existing computer systems. The supply chain management system may thus be incorporated into other existing systems without any major alteration to the system layout or functioning.

In a preferred embodiment, a “thin client model” has been chosen as the preferred method of delivering the system. The thin client architecture places the software applications and storage capacity on a central server which is accessed by remote desktop devices, which contain no moving parts or storage capacity. The desktop devices operate only to send and receive commands to and from the server. The system is designed to simplify system administration and maintenance which results in lower overall operational and ownership costs of the supply chain management system.

### BRIEF DESCRIPTION OF THE DRAWINGS

The invention will now be described by way of example only and with reference to the accompanying drawing, which presents a diagrammatic overview of a supply chain control apparatus according to an embodiment of the invention.

### DETAILED DESCRIPTION OF THE PREFERRED EMBODIMENT

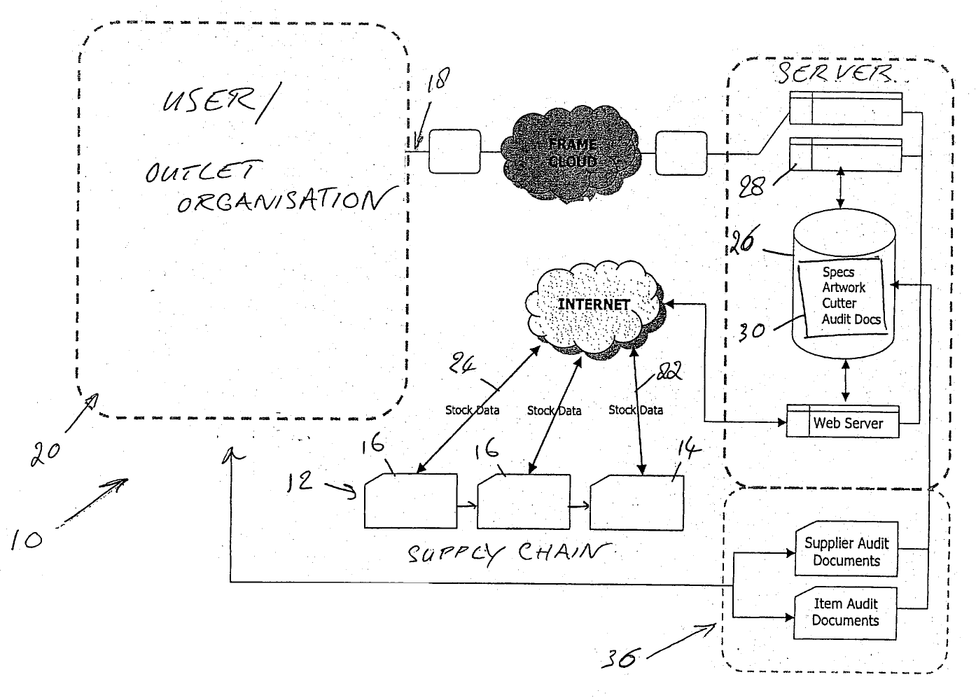

FIG. 1 presents the supply chain control apparatus 10 for controlling a supply chain 12 of a composite product by a user or outlet organization 20, the supply chain 12 including one or more primary suppliers 14 of the composite product and one or more secondary suppliers 16 of parts for the composite product. The primary suppliers 14 supply the composite product to one or more outlets (not shown) or directly to the outlet organization or user 20. The apparatus 10 comprises a storage means 26 in the form of a database which is adapted to store composite product data comprising outlet data 42, primary supplier data 44, and secondary supplier data 43. The apparatus 10 further comprises communication means 18,22,24 for providing the storage means 26 with outlet data 42, primary supplier data 44, and secondary supplier data 43. Also, the apparatus 10 comprises a control means 28 for controlling the supply of composite products and product parts, wherein the control means 28 comprises means for instructing the primary suppliers and/or secondary suppliers to supply products and/or parts and monitor means 48 for monitoring the stored composite product data and activating 50 the instruction means to enable efficient supply of products to the outlets or user 20.

The supply chain apparatus 10 is implemented on a server 40 and several clients in the form of remote desktop computers (not shown) which are located at the suppliers 14,16 and the user/ outlet organization 20. The communication means 18,22,24 are formed by remote links in the form of telephone, internet or other web based links or hard wire connections. The storage means 26 is in the form of a database 26 which is adapted to store the product data comprising outlet data 42, primary supplier data 44 and secondary supplier data 43.

The communication means 18,22,24 comprises a first communication means 18 for providing the storage means with outlet data. In the embodiment, the outlet data 18 are provided directly by the user or outlet organization 20. The communication means further comprises a second communication means 22 for providing the database 26 with primary supplier data 44. A third communication means 24 is provided for providing the database 26 with secondary supplier 16 data.

The outlet data 42 comprise outlet sales rates, outlet demand and outlet inventories. The primary supplier data 43 comprise supply rates and product supply inventories, and the secondary supplier data 44 comprise secondary supply rates and parts inventories. The primary supplier data 43 and secondary supplier data 44 can also comprise prices of the products/product parts.

Supplier data 43, 44 which relate to a single composite product are stored as a product record 30 in the database 26. These are then accessible by the control means 28 to effectively control the supply of the product. The record 30 is also accessible to the user 20 and the suppliers 14,16 via interface means so that they can monitor supply of the product.

The control means 28 is in the form of a database controller 28. The control means 28 are also adapted to receive instructions from the user 20 via a first interface means or the first communication means 18. The user/outlet organization 20 can intervene in the control of the apparatus 10 and the user can control the supply chain 12 directly via the controller 28. In addition, the user 20 can intervene and include or remove primary and secondary suppliers 14,16 from the apparatus 10 and if desired, the user 20 can select secondary and primary suppliers 14,16 and the number of products and product parts that are to be supplied directly without the intervention of the database controller 28.

The apparatus 10 further comprises further interface means for enabling the user, primary, and secondary suppliers to access the stored inventory data so that the suppliers are aware of the performance of the supply chain and the outlet inventory and demand.

The apparatus 10 also comprises audit means 36 for auditing the product inventories and ordering instructions. Data from the audit means are stored on the database 26 and are accessible by the user 20. The audit means are adapted to audit the supplier 54 and the supply of products or product parts 52.

In use, the database 26 is continuously updated with the data from the primary and secondary suppliers and the outlet. The controller 28 monitors the data and instructs the suppliers with the quantity of products to be supplied. The suppliers have access to the inventories in the supply chain via the interface means so that they are aware of the product demands and the number of products to be supplied.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An apparatus for controlling a supply chain of a composite product by a user, the supply chain including one or more primary suppliers of the composite product and one or more secondary suppliers of parts for the composite product, the primary suppliers supplying the composite product to one or more outlets, the apparatus comprising:
a storage means adapted to store composite product data comprising outlet data, primary supplier data, and secondary supplier data,
a communication means for providing the storage means with outlet data, primary supplier data, and secondary supplier data, and
a control means for controlling the supply of composite products and product parts, wherein the control means comprises means for instructing the primary suppliers and/or secondary suppliers to supply products and/or parts and monitor means for monitoring the stored composite product data and activating the instruction means to enable efficient supply of products to the outlets.

2. An apparatus for controlling a supply chain of suppliers, the supply chain supplying a composite product to one or more outlets, the apparatus comprising:
a storage means adapted to store outlet data, primary supplier data, and secondary supplier data,
communication means for providing the storage means with outlet data, primary supplier data, and secondary supplier data, and
a control means for controlling the supply of composite products and product parts on the basis of the stored data, thereby providing an efficient supply of the composite products to the outlets.

3. An apparatus according to claim 2, wherein the control means comprises means for instructing the primary suppliers and/or secondary suppliers and monitor means for monitoring the stored composite product data and activating the instruction means to enable efficient supply of products and product parts to the outlets.

4. An apparatus according to claim 1, wherein the outlet data comprise one of outlet inventory data, outlet inventory rate data, and outlet demand data, and combinations of the said data.

5. An apparatus according to claim 1, wherein the primary and secondary supplier data comprise supply rate data and inventory data.

6. An apparatus according to claim 1, wherein the monitoring means activate the instruction means if the outlet data are below a predetermined value.

7. An apparatus according to claim 1, wherein the monitor means activate the instruction means if the primary supplier inventory data and/or secondary supplier inventory data correspond to an approximate predetermined inventory level.

8. An apparatus according to claim 7, wherein the monitoring means are adapted to determine the inventory level on the basis of the outlet demand.

9. An apparatus according to claim 1, wherein the apparatus comprises first interface means for providing stored composite product data to a user.

10. An apparatus according to claim 9, wherein the control means are adapted to receive user instructions, said instructions being provided via the interface means.

11. An apparatus according claim 1, wherein the apparatus comprises second interface means for providing stored composite product data to the primary suppliers.

12. An apparatus according to claim 1, wherein the apparatus comprises third interface means for providing stored composite product data to the secondary suppliers.

13. An apparatus according to claim 9, wherein the storage means is adapted to store composite product data relating to a single composite product in a product record.

14. An apparatus according to claim 13, wherein the interface means provide access to the product record.

15. An apparatus according to claim 13, wherein the interface means are adapted to create a new record.

16. An apparatus according to claim 9, wherein the interface means comprise access means for controlling access to the inventory data.

17. An apparatus according to claim 9, wherein the interface means are adapted to communicate requests to supply from a user, and the interface means are adapted to receive offers from said primary suppliers and/or secondary suppliers.

18. An apparatus according to claim 9, wherein the storage means is adapted to store product information and/or primary supplier information and/or secondary supplier information, said information being accessible and provided by the interface means.

19. An apparatus according to claim 9, wherein the communication means comprises interface means.

20. An apparatus according to claim 1, wherein the control means comprises selection means for selecting the primary suppliers and/or the secondary suppliers.

21. An apparatus according to claim 20, wherein the selection means are adapted to select primary suppliers and/or secondary suppliers on the basis of inventory data.

22. An apparatus according to claim 20, wherein the selection means comprises cost calculating means, said selection means being adapted to select the suppliers on the basis of the calculated product/part cost.

23. An apparatus according to claim 20, wherein the selection means comprises a tender system.

24. An apparatus according to claim 18, wherein the selection means are controlled by a user.

25. An apparatus according to claim 1, wherein the apparatus is adapted to control multiple supply chains.

26. An apparatus according to claim 1, wherein the apparatus comprises audit means for auditing the supply of products and/or product parts.

27. An apparatus according to claim 26, wherein the apparatus comprises a fourth communication means for providing the audit means with stored inventory data.

28. An apparatus according to claim 1, wherein the apparatus is adapted to control the supply chains of packaged goods to a retail outlet.

29. An apparatus according to claim 1, wherein the apparatus is in the form of a computer system comprising software, a central server, and multiple clients, the software being implemented on the central server, and clients being adapted to access the server, the clients being provided with the user, primary suppliers, and secondary suppliers.

30. An apparatus adapted to control the supply of a product from a supplier to an outlet, said product comprising one or more product parts supplied by product secondary suppliers, said apparatus comprising:
a storage means adapted to store product data;
a communication means for providing the storage means with product data from the outlet and suppliers; and
a control means for controlling the supply of the products to preventing inefficient supply of products to the outlets.

31. A method of controlling a supply chain, the supply chain including one or more primary suppliers of the composite product and one or more secondary suppliers of parts for the composite product, the primary suppliers supplying the composite product to one or more outlets, the method comprising the steps of:
providing a storage means adapted to store composite product data comprising outlet data, primary supplier data, and secondary supplier data,
providing a communication means for providing the storage means with outlet data, primary supplier data, and secondary supplier data, and
providing a control means for controlling the supply of composite products and product parts, the control means comprising means for instructing the primary suppliers and/or secondary suppliers to supply products and/or parts and monitor means for monitoring the stored composite product data and activating the instruction means,
wherein the method further comprises the step of the monitoring the stored data and instructing the suppliers to enable efficient supply of products to the outlets.
